(19) United States
(12) Patent Application Publication
(10) Pub. No.: US 2015/0223635 A1
(43) Pub. Date: Aug. 13, 2015

(54) Computer Controlled Coffeemaker

(71) Applicant: HAMILTON BEACH BRANDS, INC., GLEN ALLEN, VA (US)

(72) Inventor: Patrick T. Mulvaney, Richmond, VA (US)

(73) Assignee: HAMILTON BEACH BRANDS, INC., GLEN ALLEN, VA (US)

(21) Appl. No.: 14/177,347

(22) Filed: Feb. 11, 2014

(51) Int. Cl. A47J 31/56; A47J 31/58; A47J 31/44

(52) U.S. Cl. CPC A47J 31/56; A47J 31/44; A47J 31/4482; A47J 31/58

(57) ABSTRACT

A kitchen appliance includes a hot liquid generator, at least one heater, at least one temperature sensor, a discharge port in fluid communication with the hot liquid generator, a first pump, and a controller that actuates the at least one heater to heat liquid in the hot liquid generator, receives signals from the at least one temperature sensor and records an elapsed time in which liquid in the hot liquid generator is heated from a first temperature to a second temperature, calculates the volume of the liquid in the hot liquid generator based on the elapsed time and the first and second temperatures, and compares the calculated volume to a range of expected volumes. Depending on the comparison, the controller actuates the first pump to pump liquid out of the hot liquid generator to the discharge port or outputs an error signal.

### BACKGROUND

An embodiment of the present disclosure relates generally to a kitchen appliance, and more particularly, to a computer-controlled coffeemaker.

Common coffeemakers require the placement of loose coffee grounds into a filter mounted in a brew basket. Water in the coffeemaker is heated and dripped onto the loose grounds. Resultant coffee passes through the filter and into a container such as a carafe, cup, or the like. The complaints associated with these types of coffeemakers are often related to the brew speed as some find the coffeemakers simply take too long to brew the coffee. More recently, “single-serve” coffeemakers have gained in popularity that provide the coffee grounds and filters in pre-packaged, single-serve, sealed containers. Upon placement of the container in the coffeemaker, a seal is punctured to allow hot water to enter the container. Heated water is often air-pumped through the container and expelled through a discharge port directly into a user's cup. While such systems can deliver coffee more quickly, the taste of the coffee is generally regarded as poorer when compared to traditionally brewed coffee.

It is desirable to provide a coffeemaker that can brew both loose and pre-packaged coffee grounds in a speedy and efficient manner but still promotes quality taste. It is also desirable to provide a coffeemaker that can brew and output multiple single-serve cups of coffee. A controller as disclosed here can manage and operate the coffeemaker.

### BRIEF SUMMARY

Briefly stated, an embodiment of the present disclosure comprises a kitchen appliance including a hot liquid generator having an inlet and an outlet, and configured to receive a liquid therein. At least one heater is in thermal communication with liquid in the hot liquid generator. At least one temperature sensor senses the temperature of the liquid. A discharge port is in fluid communication with the outlet of the hot liquid generator. A first pump is configured to pump liquid out of the hot liquid generator through the outlet to the discharge port. A controller is configured to (1) actuate the at least one heater to heat liquid in the hot liquid generator, (2) receive signals from the at least one temperature sensor and record an elapsed time in which liquid in the hot liquid generator is heated from a first temperature to a second temperature, (3) calculate the volume of the liquid in the hot liquid generator using the following formula:

(W×Δt)/(c×(T2−T1)×ρ)

wherein W is a wattage of the at least one heater, Δt is the elapsed time, c is a specific heat of liquid in the hot liquid generator, T1 is the first temperature, T2 is the second temperature, and ρ is a density of liquid in the hot liquid generator, and (4) compare the calculated volume of liquid in the hot liquid generator to a range of expected volumes of liquid in the hot liquid generator, whereby if the calculated volume is within the range of expected volumes, the controller is configured to actuate the first pump to pump liquid out of the hot liquid generator through the outlet to the discharge port, and if the calculated volume is outside of the range of expected volumes, the controller is configured to output an error signal.

Another embodiment of the present disclosure comprises a method of operating a kitchen appliance having a hot liquid generator, at least one heater in thermal communication with liquid in the hot liquid generator, a discharge port in fluid communication with the hot liquid generator, and a controller. The method includes using the at least one heater, heating liquid in the hot liquid generator from a first temperature to a second temperature, calculating an elapsed time in which liquid in the hot liquid generator was heated from the first temperature to the second temperature, calculating, using the controller, a volume of liquid in the hot liquid generator using the following formula:

(W×Δt)/(c×(T2−T1)×ρ)

wherein W is a wattage of the at least one heater, Δt is the elapsed time, c is a specific heat of liquid in the hot liquid generator, T1 is the first temperature, T2 is the second temperature, and ρ is a density of liquid in the hot liquid generator, and comparing, in the controller, the calculated volume of liquid in the hot liquid generator to a range of expected volumes of liquid in the hot liquid generator. If the calculated volume is within the range of expected volumes, liquid is pumped out of the hot liquid generator to the discharge port. If the calculated volume is outside of the range of expected volumes, an error signal is output by the controller.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustration, there is shown in the drawings embodiments which are presently preferred. It should be understood, however, that the invention is not limited to the precise arrangements and instrumentalities shown.

In the drawings:

FIG. 1A is a top front perspective view of a kitchen appliance according to a first embodiment;

FIG. 1B is another top front perspective view of the kitchen appliance of FIG. 1A with the drawer removed;

FIG. 1C is a top rear perspective view of the kitchen appliance of FIG. 1A with the reservoir removed;

FIG. 2 is a schematic block diagram of certain components of the kitchen appliance of FIG. 1;

FIG. 3A is a flow chart of a power on sequence performed by a controller of the kitchen appliance of FIG. 1 in accordance with the first embodiment;

FIG. 3B is a flow chart of a purge sequence initiated by the controller of the kitchen appliance of FIG. 1 in accordance with the first embodiment;

FIGS. 3C-3E are a flow chart of a brew cycle initiated by the controller of the kitchen appliance of FIG. 1 in accordance with the first embodiment;

FIG. 4 is a top front perspective view of a kitchen appliance in accordance with a second embodiment;

FIG. 5 is a schematic block diagram of certain components of the kitchen appliance of FIG. 4; and

FIG. 6 is a flow chart of a portion of a brew cycle initiated by one of the controllers of the kitchen appliance of FIG. 4 in accordance with the second embodiment.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

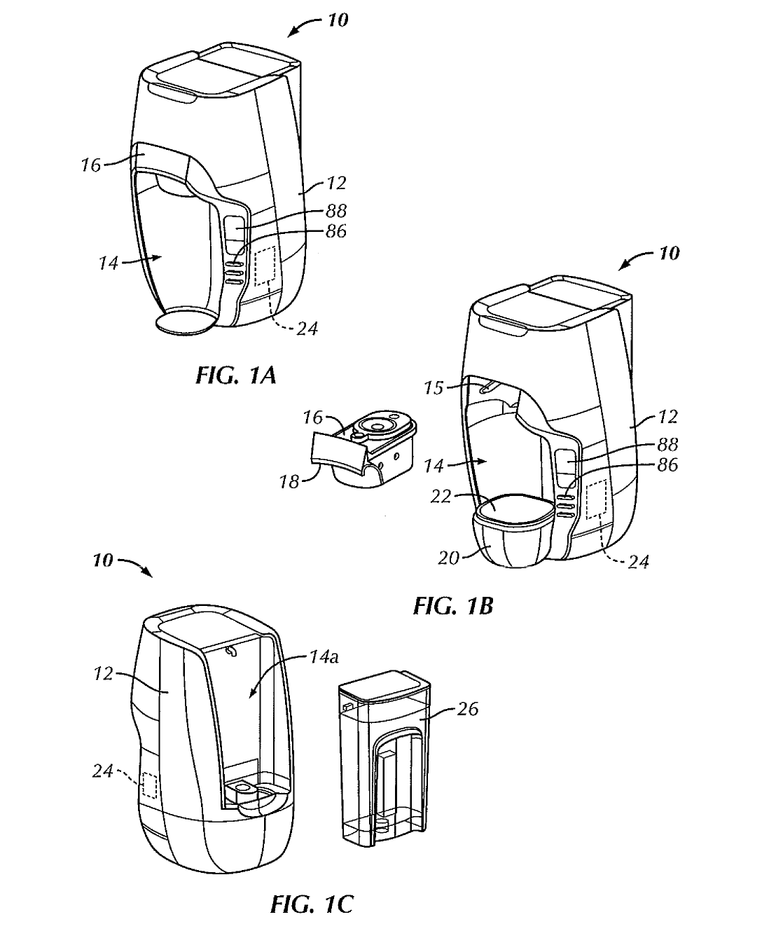

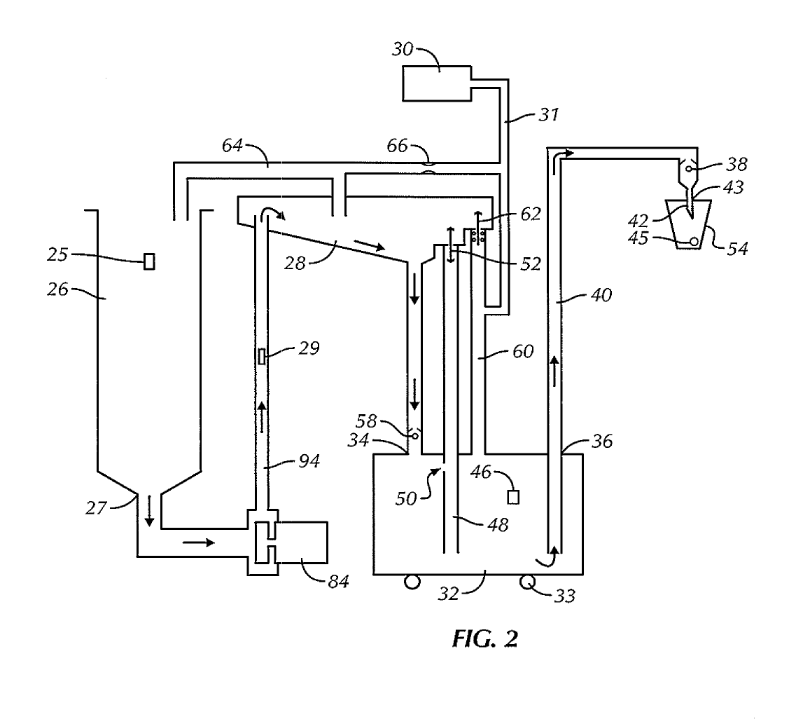

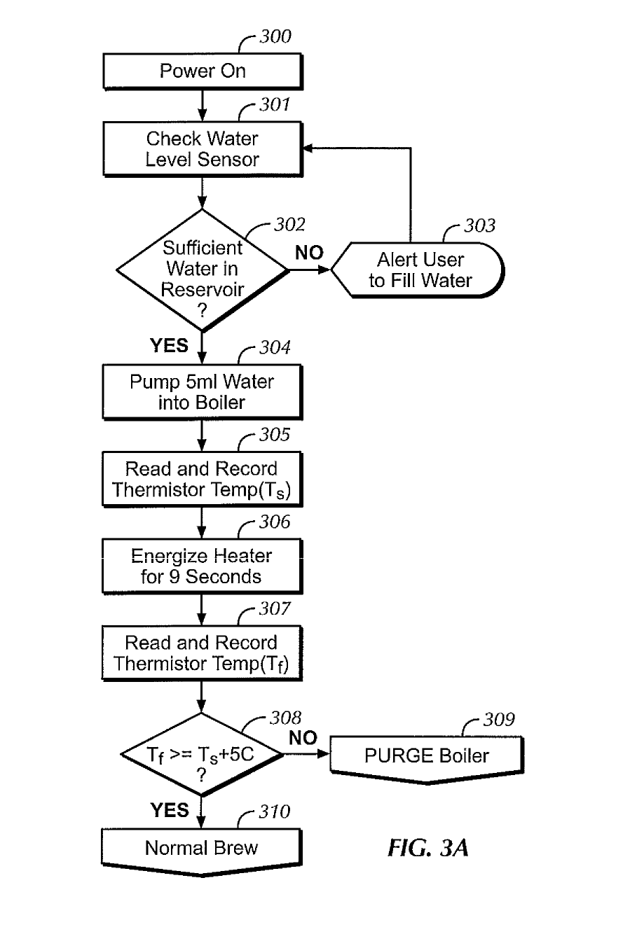

Referring to the drawings in detail, wherein the same reference numerals indicate like elements throughout, there is shown in FIGS. 1A-1C a kitchen appliance, generally designated 10, in accordance with a first preferred embodiment. The kitchen appliance 10 is intended or designed for preparing a beverage from foodstuff (not shown) to be consumed by a user. Although the kitchen appliance 10 may be generally referred to as a “coffeemaker,” wherein coffee is prepared from coffee grounds, the kitchen appliance is preferably capable of making other beverages from extractable/infusible foodstuff as well, such as tea leaves, hot chocolate powder, soup ingredients, oatmeal, and the like. Thus, the kitchen appliance 10 is versatile because it may be used to create and/or prepare any one of a variety of different types of beverages from a variety of different types of foodstuff. More specifically, the kitchen appliance 10 preferably heats a liquid, such as water, to a sufficient temperature to be combined with or poured over the foodstuff to create a hot beverage.

The kitchen appliance 10 is also versatile because it preferably allows a user to create a beverage from foodstuff in any one of a variety of different forms or states. For example, the kitchen appliance 10 may be used to make coffee or tea from loose coffee grounds or leaves, coffee grounds or leaves contained in a generally soft packet (i.e., a flexible coffee “pod” or a tea bag), or coffee grounds or tea leaves contained in a generally hard container (i.e., a rigid coffee or tea “pod”). The foodstuff is preferably inserted into at least a portion of the kitchen appliance 10. Following completion of preparation of the beverage, any moist or saturated foodstuff remaining in the kitchen appliance 10 is preferably removed and either recycled or discarded.

The kitchen appliance 10 includes an outer housing 12 for enclosing and protecting internal components of the kitchen appliance 10, as described in detail below. The housing 12 and/or any components thereof may be constructed from any polymer, metal or other suitable material or combinations of materials. For example, an injection molded acrylonitrile butadiene styrene (ABS) material and/or polypropylene could be employed, but the housing may be constructed of nearly any generally rigid material that is able to take on the general shape of the housing 12 and perform the functionality of the housing 12 described herein. The housing 12 may be generally or completely or partially opaque, translucent or transparent.

The housing 12 preferably includes a recess 14 that is preferably sized, shaped and/or configured to receive and/or support at least a portion of cup, pot, travel mug or other vessel (not shown) for receiving a beverage or liquid that exits the kitchen appliance 10. The beverage preferably flows, drips or otherwise accumulates in the vessel, which is subsequently removed from the recess 14 by the user prior to consumption of the beverage. A drawer 16 is preferably removably attachable to the housing 12 and positioned directly above the recess 14 when properly attached to the housing 12. Whether removable or not, in a fully-inserted position (see FIG. 1A), at least an outer peripheral portion of the drawer 16 rests on a ledge 15 in an interior of the housing 12 and/or in the recess 14. The drawer 16 preferably slides laterally along the ledge when the drawer 16 is inserted into and/or removed from the housing 12. The drawer 16 preferably includes a handle 18 that extends outwardly beyond at least a portion of the housing 12. The drawer 16 also preferably holds the foodstuff used to prepare the beverage, and is described in more detail below, and may include a filter (not shown) therein. A drip tray or grate 22 may be positioned proximate a lower end of the recess 14 to receive any excess beverage or liquid is not received or retained in the vessel. Grate 22 acts as a cup support and may be attached to a bin 20 which holds the excess beverage or liquid.

The housing 12 preferably includes at least an on/off button 86. The kitchen appliance 10 of the present embodiment prepares a beverage of a single-serving size (which is up to approximately 14 ounces of prepared beverage), although it is envisioned that the embodiments disclosed herein could be operative with larger serving sizes (i.e., a pot or carafe) as well. Depressing the on/off button 86 preferably begins an operating cycle, and subsequent depressing the on/off button 86 preferably ends an operating cycle. The phrase “operating cycle” is broadly defined herein as a period of time when the kitchen appliance 10 is first activated to when the beverage is fully prepared and the kitchen appliance 10 is deactivated. The appliance performs both pressurized and un-pressurized brewing cycles. For each pressurized operating cycle, there can be a plurality of pressure/vacuum cycles, as described in detail below, which preferably act to increase an average pressure of fluid within the kitchen appliance 10 to prepare the beverage. The kitchen appliance 10 may automatically turn off or deactivate once the operating cycle is complete, as described below. The kitchen appliance 10 is not limited to including a single on/off button 86. For example, additional buttons, knobs, switches and/or levers could be added to the kitchen appliance 10 to allow the user increased control over the functionality and/or operation of the kitchen appliance 10.

The housing 12 also preferably includes a display 88. The display 88 is preferably a liquid crystal display (LCD) capable of displaying and cycling through at least three separate icons for small, medium and large sizes of the vessel that receives the prepared beverage. In operation, a user preferably chooses a vessel size on the display 88 and then presses the on/off button 86 to initiate an operating mode or cycle. Alternatively, the user can simply press the on/off button 86 to brew the same vessel size as the last operating mode or cycle. It is preferred that the on/off button 86 can be pressed at any time to cancel the operating mode or cycle. The on/off button 86, any additional buttons or levers, and the display 88 are all preferably coupled to a controller 24 (shown in phantom in FIGS. 1A-1C) for operation of the kitchen appliance 10, as will be described in further detail below.

The controller 24 may be any type of controller, such as a microprocessor, multiple processors, or the like. The controller 24 preferably includes or is operatively coupled to a memory (not shown) that stores the code described below and any additional code or software for carrying out operation of the kitchen appliance 10. The controller 24 may also include, as hardware or software, or may be operatively connected to other components, such as clocks, timers, or the like (not shown) needed for operating the kitchen appliance 10.

A reservoir 26 for receiving and/or holding liquid to be used for preparing a beverage is preferably selectively removable from the housing 12. The term “reservoir” is broadly used herein throughout as a body, cavity, or conduit that holds a volume of liquid. As shown in FIGS. 1A-1C, the reservoir 26 may be removably attachable to a rear side of the housing 12. A second recess 14a on a rear side of the housing 12 is preferably sized, shaped and or configured to complementarily receive the reservoir 26.

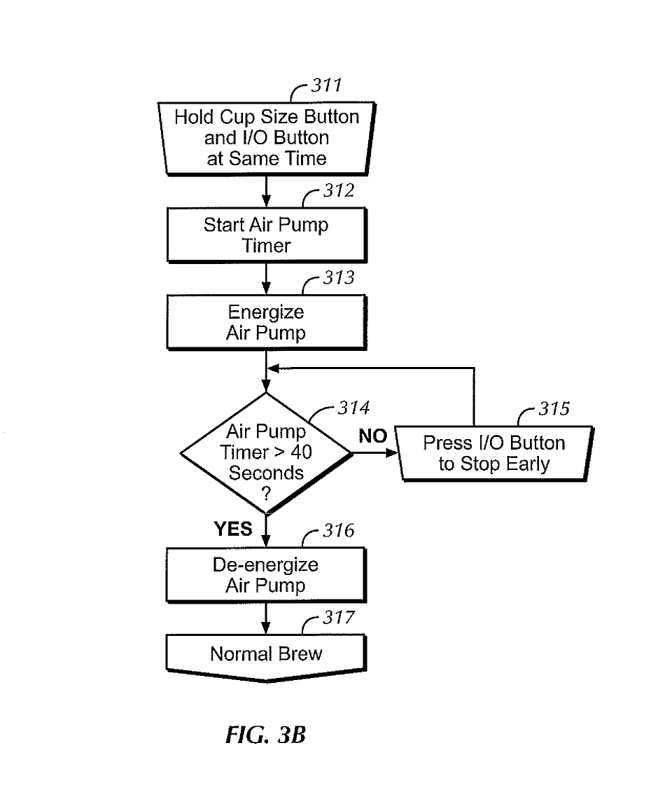

FIG. 2 is a schematic block diagram of various components of the kitchen appliance 10 to illustrate the flow of fluid from the reservoir 26 through discharge. The reservoir 26 is preferably sized, shaped and/or configured to receive at least an amount of liquid that is suitable for preparing a consumer-selected amount of the beverage. Alternatively, the reservoir 26 may be sufficiently sized to receive an amount of liquid that is capable of filling an entire pot of approximately one liter, for example. An outlet 27 is formed in a lower portion of the reservoir 26, and at least a portion of a bottom wall of the reservoir 26 may be slanted or sloped to direct liquid within the reservoir 26 toward the outlet 27.

The outlet 27 of the reservoir 26 is fluidly connected to an inlet manifold 28 in a manner to transmit fluid to the inlet manifold 28 but not vice versa. The reservoir 26 is preferably not air-tight, such that the reservoir 26 is maintained at atmospheric pressure. At least one optional liquid level sensor 25, such as a magnetic float switch or the like, may be located in, on, and/or near the reservoir 26. The liquid level sensor 25 is preferably operatively connected to and/or in communication with the controller 24.

As shown in FIG. 2, a pump 84 is preferably positioned between and/or operatively connects the reservoir 26 and the inlet manifold 28. A fill or riser tube 94 preferably fluidly connects the pump 84 to the inlet manifold 28. The pump 84 is not limited to being a certain type of pump, as the pump 84 may be a positive displacement pump, a water pump or an air pump, for example. The pump 84 preferably forces liquid from the outlet 27 of the reservoir 26 into the inlet manifold 28. Operation of the pump 84 can be automatic or controlled by a user through selective manipulation of the display 88 and/or the on/off button 86. The pump 84 can dispense or pump a user-chosen volume of liquid (e.g., small, medium or large) as determined by a time-based algorithm, a flow meter, or other mechanism. Alternatively, a sensor 29, preferably located inside the housing 12, such as in the fill tube 94, may detect a level of liquid in the reservoir 26 and alter or modify operation of the pump to compensate for loss of pumped volume associated with reduced head height in the reservoir 26. In one exemplary embodiment, the sensor 29 may be a capacitance sensor that senses the permittivity of the liquid in the reservoir 26 and controls the pump 84 accordingly. In another exemplary embodiment, the sensor 29 may be a flow meter used to measure the amount of liquid that passes to the inlet manifold 28 and controls the pump 84 accordingly. A flow meter would detect pulses of water traveling up the riser tube and report each pulse to the controller. The controller determines the total volume pumped based on a fixed volume of water for each pulse that travels up the riser tube.

The kitchen appliance 10 preferably includes at least one hot liquid generator 32 and at least one heater 33 in thermal communication with liquid in the hot liquid generator 32. The hot liquid generator 32 is, for example, a boiler or the like, and for simplicity will be referred to as a boiler 32 hereafter. However, the hot liquid generator 32 need not be a boiler and may instead be in the form of a generally U-shaped, tubular, aluminum extrusion, or the like. The heater 33 is preferably located outside of and in contact with the boiler 32 to heat the liquid therein. However, the heater 33 may also be located inside the boiler 32 in direct physical contact with the liquid. The boiler 32 preferably includes an inlet end 34 (i.e., upstream side) and an outlet end 36 (i.e., downstream side). The inlet end 34 of the boiler 32 is fluidly connected to at least a portion of the reservoir 26 for receiving liquid therefrom, preferably via the inlet manifold 28. The phrase “fluidly connected” is broadly used herein as being in direct or indirect fluid communication.

The kitchen appliance 10 preferably includes an inlet check valve 58 positioned between the reservoir 26 and the boiler 32, more preferably between the inlet manifold 28 and the boiler 32. The inlet check valve 58 prevents liquid from flowing out of the boiler 32 toward the reservoir 26. The inlet check valve 58 and any other check valves described herein may be any type of one-way valve, such as a silicone flapper, a ball-type valve, a diaphragm-type valve, a duckbill valve, an in-line valve, a stop-check valve, a lift-check valve, or the like.

A discharge port 42 is preferably in fluid communication with the boiler 32 via the outlet end thereof 36. A discharge or riser tube 40 preferably fluidly connects the boiler 32 to the discharge port 42. The discharge port 42 may include one or more relatively small or narrow internal passageway(s). At least a portion of a bottom wall of the discharge tube 40 could be slanted or sloped to direct liquid toward the discharge port 42. A lower tip of the discharge port 42 can be sharp or pointed for piercing a “pod,” container, or the like. Liquid may exit the discharge port 42 at an angle with respect to a longitudinal axis of the discharge port 42. In particular, liquid may exit the discharge port 42 at an angle between approximately thirty and ninety degrees)(30°-90° with respect to a longitudinal axis of the housing 12. However, liquid may exit the discharge port 42 in a manner that is parallel to the longitudinal axis of the housing 12. Other geometric arrangements would also be suitable. In another embodiment, outlet port 42 may resemble a more conventional showerhead of an automatic drip coffeemaker (ADC) for use with loose infusible material.

As previously described, the kitchen appliance may be used with either loose or softly packed foodstuff, or with foodstuff packed in a hard pod or other container. In the latter case, the kitchen appliance 10 includes or works in combination with a container 54 that at least partially encloses the foodstuff used to prepare the beverage. The container 54 may include a generally rigid body and a cap or foil top removable therefrom. The container 54 may be a K-CUP® coffee pack, a rigid pod, or any other structure that is capable of holding or storing foodstuff. The container 54 is preferably removably insertable into the drawer 16. When the container 54 is properly inserted into the drawer 16 and the drawer 16 is properly attached to the housing 12, an interior of the container 54 is preferably fluidly connected to the discharge port 42. More specifically, the discharge port 42 may be at least partially inserted into the container 54, such that a tip or distal end of the discharge port 42 pierces or is otherwise inserted into the cap of the container 54.

Prior to being inserted into the housing 12, the container 54 may be air-tight. However, once the container 54 is properly inserted into the drawer 16 and the drawer 16 is properly inserted into the housing 12, at least two spaced-apart holes are preferably formed or present in the container 54. A first hole 43 exists by or at the discharge port 42 piercing or being inserted into the cap. Thus, the first hole 43 is preferably formed in an upper end of the container 54. The first hole 43 can be formed by moving the container 54 with respect to the generally stationary discharge port 42. However, the first hole 43 may be formed by moving the discharge port 42 with respect to the container 54, which may be held stationary. A width or diameter of the first hole 43 is preferably approximately the same as that of the discharge port 42 to provide a tight fit between the first hole 43 and the discharge port 42. A second hole 45 is present or formed preferably in or near a lower end of the container 54 and vertically below a foodstuff within the container 54. The second hole 45 can be formed during and/or after the container 54 is properly inserted into the drawer 16.

If loose grounds or the like are instead to be inserted in the drawer 16, a basket or other type of container (not shown) may be utilized to hold the grounds for operation of the kitchen appliance 10. The basket may include a filter (not shown) or be configured to receive a conventional or specialized filter to facilitate infusion of the loose grounds with the liquid. In the event that the loose grounds are inserted into the drawer 16 in a soft container, the pointed end of the discharge port 42 may be used to create an opening therein. It may also be possible to utilize containers that are dissolvable in the drawer 16.

A check valve 38, similar to the check valve 58 located between the boiler 32 and the inlet manifold 28, is preferably placed proximate the discharge port 42 to prevent fluid flow back into the discharge tube 40 and the boiler 32.

An air pump 30 is provided for moving liquid in the boiler 32 through the discharge tube 40 to the discharge port 42. Operation of the air pump 30 can be automatic or controlled by a user through selective manipulation of the display 88 and/or the on/off button 86. The air pump 30 preferably empties the boiler 32 of liquid. As will be described in detail below, in the particular embodiment shown in FIG. 2, operation of the air pump 30 is controlled via the controller 24 using feedback from at least one temperature sensor 46 that senses the temperature of liquid in the boiler 32.

Since the boiler 32 is closed, a vent tube 48 is provided to allow escape of air from the boiler 32 so that water can enter from the inlet manifold 28 through the inlet 34. The vent tube 48 preferably extends proximate to a bottom inner surface of the boiler 32 and includes a vent orifice 50 proximate a top inner surface of the boiler 32. The vent tube 48 further extends out of the boiler 32 and into the inlet manifold 28. A vent valve 52 is preferably provided between the inlet manifold 28 and the vent tube 48 and is typically in an “open” position so as to allow water to flow through the inlet 34 into the boiler 32. The vent valve 52 is preferably a needle valve or the like, although other types of valves can be used as well. During operation of the air pump 30, water enters the vent tube 48 at the bottom of the boiler 32 and travels up the vent tube 48 to force the vent valve 52 into a “closed position,” which forces the water to the outlet 36 for proceeding to the discharge port 42.

An overpressure tube 60 is also preferably provided and connected to the boiler 32 and the inlet manifold 28. An overpressure valve 62, which is preferably in the form of a spring biased needle valve or the like, is located between the overpressure tube 60 and the inlet manifold 28. In the event that an abnormally high amount of pressure builds up in the boiler 32, such as due to the malfunctioning of the heater 33, air is allowed to escape through the overpressure valve 62 to relieve the excessive pressure. In the embodiment shown in FIG. 2, a pump line 31 from the air pump 30 joins the overpressure tube 60 for communicating with the boiler 32. However, other methods of connecting the air pump 30 to the boiler 32 can be used as well.

An overflow tube 64 is also preferably provided in fluid communication with the inlet manifold 28. In the event of a back-up at the inlet 34 of the boiler 32 which causes an excessive amount of water to accumulate in the inlet manifold 28, the water can be taken up into the overflow tube 64 and discharged back into the reservoir 26. Further, the pump line 31 for the air pump 30 is preferably connected to the overflow tube 64 via an orifice 66. In lower pressure conditions (e.g., when the air pump 30 is not energized), the orifice 66 creates very little back pressure. However when the air pump 30 is energized, creating a higher pressure environment, the orifice is sized to sufficiently restricts air flow to facilitate the pressure increase. The air pump 30 blows any accumulated vapor or excess water in the overflow tube 64 into the reservoir 26 and/or the inlet manifold 28.

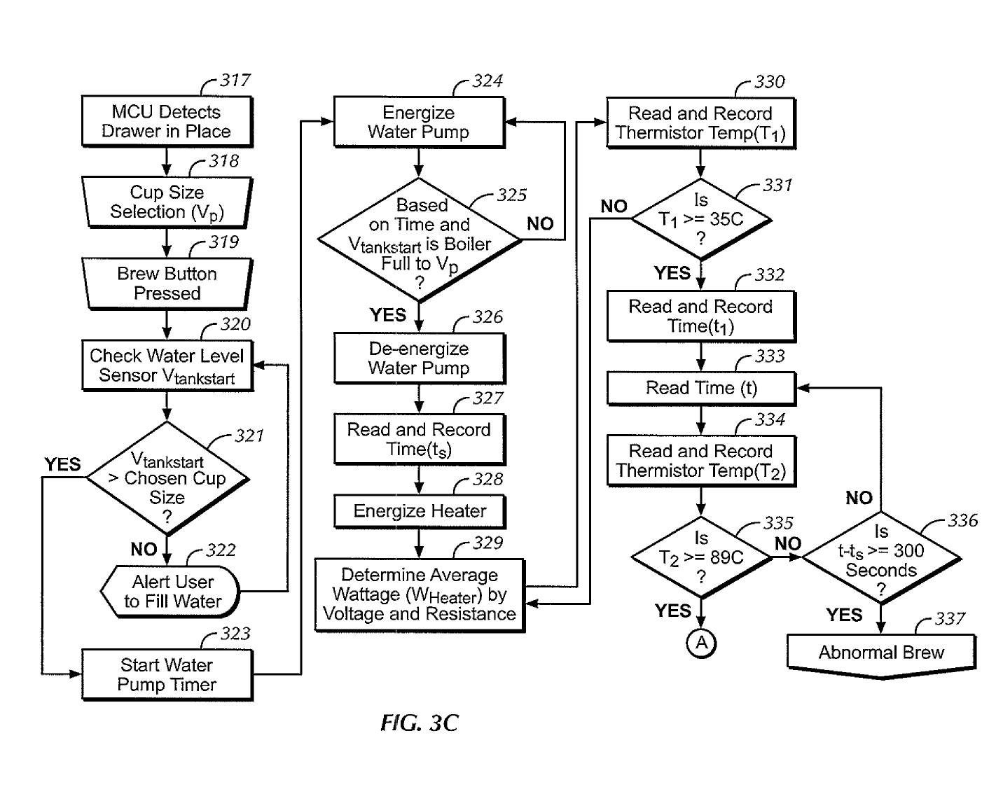

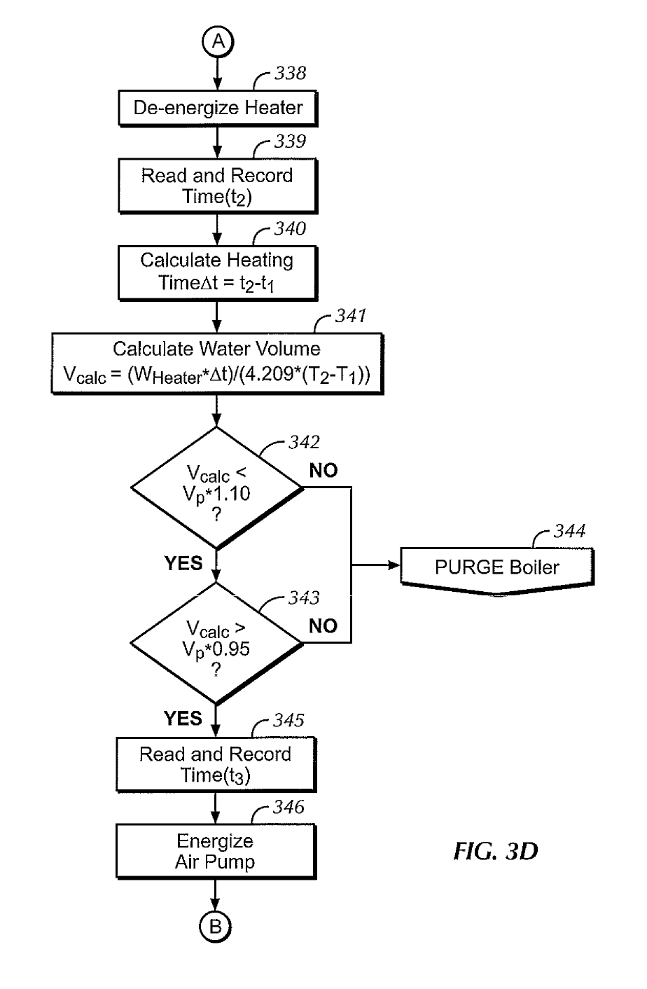

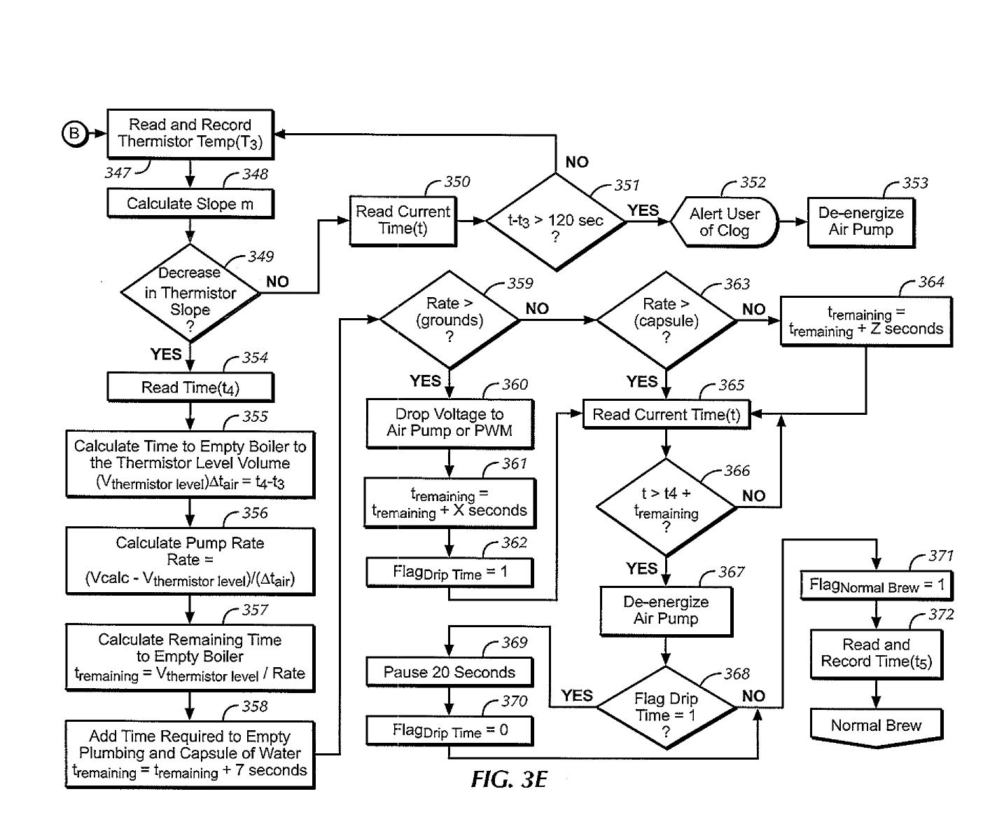

Operation of the controller 24 of the kitchen appliance 10 of FIGS. 1A-2 will now be described in conjunction with a liquid level sensor. Referring to FIG. 3A, a power on sequence of the controller 24 is shown. The power on sequence is preferably utilized when the kitchen appliance 10 is plugged into an outlet, recovers from a power failure, or the like. At power on 300, a splash screen and/or blinking clock may be provided on the display 88 to indicate the condition of the kitchen appliance 10 to the user. At 301, the controller 24 enters into communication with the liquid level sensor 25 in the reservoir 26 to determine at 302 whether there is a sufficient amount of water in the reservoir 26. If there is not sufficient water in the reservoir 26, an alert is made to the user at 303, preferably through a message on the display 88, that the reservoir needs to be filled. It is preferred that the alert 303 is made when the liquid level sensor 25 detects eight (8) ounces or less of water is present in the reservoir 26.

If there is sufficient water in the reservoir 26, the controller 24 initiates a sequence to check the condition of the boiler 32. Specifically, at 304 a small amount of water, for example about five (5) mL, is pumped from the reservoir 26 into the boiler 32. At 305, a starting temperature T_{S} of the temperature sensor 46 in the boiler 32 is read and recorded. The heater 33 is then energized for a short, predetermined period of time at 306, for example nine (9) seconds. The amount of time should be selected such that the heater 33 has sufficient time to burn off the small amount of water into steam if the boiler 32 was initially empty. After the heater 33 is shut off, a final temperature T_{f} of the temperature sensor 25 in the boiler 32 is read and recorded at 307.

At 308, the starting and final temperatures T_{S} and T_{f} are compared. If a difference between the temperatures T_{S}, T_{f} is less than a predetermined amount, for example 5° C., then the controller 24 at 309 moves to a sequence for purging the boiler 32, as shown in FIG. 3B. If the difference is greater than the predetermined amount, then the controller at 310 moves to a normal brew sequence, as shown in FIGS. 3C-3E.

Referring to FIG. 3B, the purge sequence will now be described. For example, at 311, the controller 24 detects the selection of a button, combination of buttons, or sequence of buttons indicating that the user wishes to purge the boiler 32. In the embodiment shown in FIG. 1, the user may initiate the purge sequence by pressing and holding a cup size button (not shown) and the on/off button 86 at the same time. Alternatively, a designated purge button (not shown) may be provided. At 312, the controller 24 starts a timer for the air pump 30 and at 313 energizes the air pump 30 to move any water left into the boiler 32 to the outlet end 36 toward the discharge port 42. It is preferred that a user places a cup beneath the discharge port 42 to catch the purged water. However, a further purge line (not shown) could be provided to dispense the purged water as an alternative to purging through the discharge port 42. It is preferred that a message is provided to the user on the display 88 during a purge operation.

At 314, the controller 24 checks the timer. If the air pump 30 has not been running for more than a predetermined period of time (e.g., forty (40) seconds), then the air pump 30 continues to run unless the user wishes to stop the purge process early, such as if the user observes that the air pump 30 continues to run but no further water is being discharged. At 315, the user may stop the purge process by pressing a predetermined button, such as the on/off button 86. If the controller 24 at 314 determines that the air pump 30 has been running for more than the allotted time, at 316 the controller 24 de-energizes the air pump 30. The controller 24 at 310 thereafter moves into the normal brew cycle, which will now be described with reference to FIGS. 3C-3E.

Once the user adds a capsule or loose grounds to the drawer 16 and replaces the drawer 16 into the housing 12 of the kitchen appliance 10, at 317, the controller 24 preferably determines whether the drawer 16 is in place. A sensor (not shown) can be used to detect the presence of the drawer 16. The controller 24 thereafter at 318 detects a selection by the user of a cup size Vₚ. If the user neglects to select a cup size, then the controller 24 preferably defaults to the last cup size which was brewed. In the preferred embodiment, the appropriate cup-size is presented on the display 88 in response to a user selection. The controller 24 at 319 detects a selection by the user of a button to initiate brewing, which may be a dedicated button or, in the embodiment shown in FIGS. 1A-1C, the on/off button 86. It is preferred that a power indicator light (not shown) or a portion of the display 88 is illuminated during brewing as an indication to the user. At this time, if desired, the controller 24 can check whether the clock on the display 88 has been set. If not, the clock digits and AM/PM indications may be turned off prior to continuing with the normal brewing procedure.

At 320, the controller 24 enters into communication with the liquid level sensor 25 in the reservoir 26 to determine at 321 whether there is a sufficient amount of water Vₜₐₙₖₛₜₐᵣₜ in the reservoir 26 to fill the selected cup size Vₚ. If not, an alert is made to the user at 322, preferably through a message on the display 88, that the reservoir 26 needs to be filled. If the reservoir 26 contains enough water to fill the demand, the controller at 323 starts a timer for the water pump 84 and at 324 energizes the water pump 84 to begin pumping water from the reservoir 26 into the boiler 32. The water pump 84 is preferably run for a predetermined amount of time based on the starting level of the water Vₜₐₙₖₛₜₐᵣₜ in the reservoir 26 and the selected cup size Vₚ. The controller 24 determines whether this condition is met at 325, and if not, continues to run the water pump 84. Once the controller 24 determines, based on time elapsed, that the water level in the boiler 32 is equal to the selected cup size Vₚ, the controller 24 at 326 de-energizes the water pump 84.

At 327, the controller 24 reads and records a heating start time tₛ and at 328 energizes the heater 33. At 329, an average wattage of the heater 33 is determined, based on voltage and resistance. Also, at 330, a first temperature T₁ is read and recorded from the temperature sensor 46 in the boiler 32. The controller 24 at 331 then determines whether the first temperature T₁ is greater than or equal to a preset starting value. In the example of FIG. 3C, the preset starting value is 35° C. If the first temperature T₁ is below the preset starting value, the controller 24 may return to 329 to determine the wattage of the heater 33, as the value may change in order to heat the water in the boiler 32 within a reasonable amount of time.

If the first temperature T₁ is at or above the preset starting value, then the controller 24 at 332 reads and records an initial time t₁. Thereafter, the controller 24 at 333 periodically reads the current time t and at 334 reads and records a second temperature T₂. At 335, the controller 24 determines whether the second temperature is at or above a preset final value, such as 89° C. in the embodiment of FIG. 3C. If not, the current time t is compared to the heating start time tₛ at 336, and if the difference is more than a predetermined amount of time (e.g., 300 seconds), the controller 24 determines at 337 that an abnormal brew has occurred, and an error message is provided to the user, preferably via the display 88. If the predetermined amount of time has not elapsed since the heating start time tₛ, the process returns to 333.

Referring to FIG. 3D, if the controller 24 determines that the second temperature T₂ is at or above the preset final value, the heater 33 is de-energized at 338 and an end time t₂ is read and recorded at 339. The total heating time Δt is then calculated at 340 by subtracting the initial time t₁ from the end time t₂. Note that the initial time t₁ is preferably used (i.e., the time at which the first temperature T₁ met or exceeded the preset starting value) rather than the heating start time tₛ.

With this information, the controller 24 at 341 calculates the volume of the water V_{calc} in the boiler 32 using the following formula:

(W×Δt)/(c×(T₂−T₁)×ρ)

wherein W is the average wattage of the heater 33, Δt is the total heating time, c is a specific heat of the liquid in the boiler 32, T₁ is the first temperature at the initial time t₁, T₂ is the second temperature, and ρ is a density of liquid in the boiler 32.

At 342 and 343, the controller 24 can use the calculated volume of water V_{calc} in the boiler 32 to determine whether certain error conditions have occurred, such as an early brew stop, clogged hose, removal of the reservoir 26 during water pumping, or the like. Using the selected cup size Vₚ as an expected volume of the water in the boiler 32, the calculated volume of water V_{calc} is compared to the expected volume Vₚ. If the calculated volume of water V_{calc} is not within a certain tolerance range of the expected volume of water Vₚ (for example within +10%/−5%), at 344 the controller 24 determines that an error has occurred and initiates the purge procedure shown in FIG. 3B. If the calculated volume of water V_{calc} is within the tolerance range of the expected volume of water Vₚ brewing proceeds at 345 as the controller 24 records an initial evacuation time t₃ and at 346 energizes the air pump 30 to begin moving the heated water from the boiler 32 to the discharge port 42.

Referring to FIG. 3E, a third temperature T₃ is also read and recorded from the temperature sensor 46 in the boiler 32 at 347. The controller 24 at 348 calculates a slope m, which represents a change in temperature over time. A decrease or large negative slope in the slope m will correspond to the water level in the boiler 32 dropping below the level of the temperature sensor 46. At 349, the controller 24 checks for a decrease in the slope m. If no decrease is found, the current time t is read at 350 and compared to the initial evacuation time t₃ at 351. If less than a predetermined amount of time has elapsed, for example 120 seconds, the controller 24 returns to 347 to read the third temperature T₃ again. If more than 120 seconds has elapsed, the controller 24 assumes that a clog has occurred at the discharge port 42 and the user is alerted at 352, preferably through the display 88. The air pump 30 is also de-energized at 353 to prevent any damage resulting from the clog. The controller 24 thereafter preferably awaits corrective action by the user prior to resuming brewing operations.

When the controller 24 detects an decrease (or increase, depending on graph axis labels) in the slope m at 349, a temperature sensor exposure time t₄ is read at 354. The controller 24 then calculates the amount of time Δtₐᵢᵣ it took for the air pump 30 to empty the boiler 32 from its initial level to the level of the temperature sensor 46 at 355. Using the initial calculated volume of water V_{calc}, the known volume of the water at the level of the temperature sensor Vₜₕₑᵣₘᵢₛₜₒᵣₗₑᵥₑₗ, and the calculated time required to empty the boiler 32 to the level of the temperature sensor 46, a pump rate is determined at 356. The controller 24 at 357 then determines the time remaining t_{remaining} to empty the boiler 32 at the current rate. The time remaining t_{remaining} may be supplemented at 358 by a brief duration required to empty the plumbing of the appliance 10, for example by adding 7 seconds to the time remaining t_{remaining}.

The controller 24 preferably also uses the calculated pump rate to determine the nature of the grounds placed in the drawer 16, and uses that information to adjust the brewing operation accordingly. For example, at 359 the controller 24 compares the calculated rate to a set rate associated with loose grounds in the drawer 16. If the calculated rate exceeds the rate set for loose grounds, at 360 the controller 24 reduces the power applied to the air pump 30 to slow the pump rate. The controller 24 then further supplements the time remaining t_{remaining} at 361 and sets a flag Flag_{Drip Time} equal to 1 at 362, which is later used as an indication when the air pump 30 is de-energized that additional time is needed to allow all of the water to drip out of the discharge port 42.

If the pump rate is not higher than the set rate for loose grounds, at 363 the controller 24 compares the calculated pump rate to a set rate associated with loose grounds or a soft pod (both of which do not create significant back pressure). If the pump rate is below the set rate for a soft pod, the controller 24 determines that a hard capsule (i.e., high back pressure brewing) is present and further supplements the time remaining t_{remaining} at 364 in order to account the difficulties associated with hard capsules (e.g., a dropped filter or the like).

After any of steps 362, 363, or 364, the controller 24 reads the current time t at 365 and at 366 determines whether the current time is greater than the sum of the temperature sensor exposure time t₄ and the established time remaining t_{remaining}. Once the controller 24 establishes that the current time exceeds the sum, the air pump 30 is de-energized at 367.

The controller 24 then checks the drip time flag Flag_{Drip Time} at 368 to see if additional drip time is required. If the flag is set to 1, the controller 24 will wait a predetermined amount of time (e.g., twenty seconds) at 369, reset the drip time flag Flag_{Drip Time} to 0 at 370, and indicate to the user that the brewing is completed, preferably by de-illuminating an indicator on the display 88. Following reset of the drip time flag Flag_{Drip Time}, or if the controller 24 determines at 368 that the drip time flag Flag_{Drip Time} is not set to 0, the controller 24 at 371 sets a normal brew flag Flag_{Normal Brew} to 1 and at 372 reads and records a completion time t₅. At this point a normal brew has been completed and the controller 24 awaits the next brew cycle.

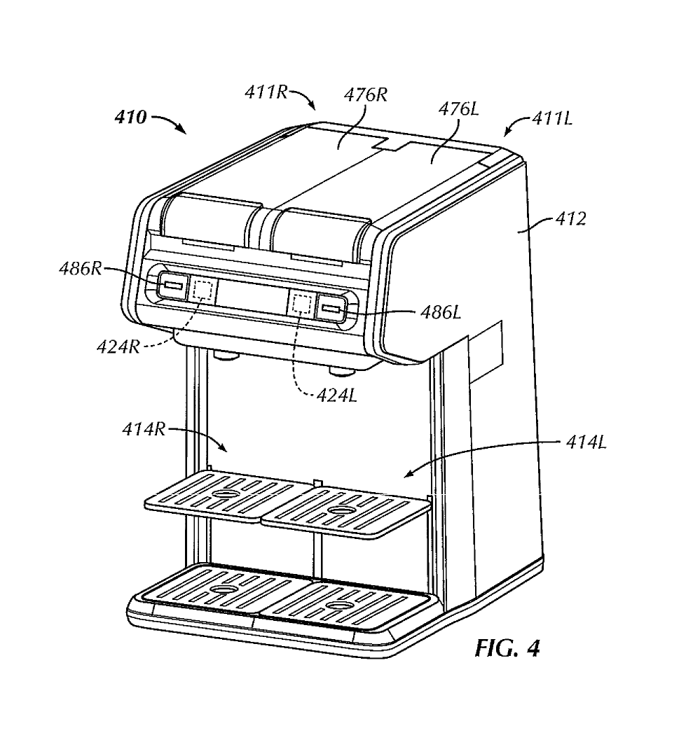

FIG. 4 illustrates a second embodiment of the kitchen appliance 410. Like numerals have been used for like elements, except the 400 series numerals have been used for the second embodiment. Accordingly, a complete description of the second embodiment has been omitted, with only pertinent differences being described herein.

The kitchen appliance 410 according to the second embodiment preferably includes two brewing units 411L, 411R for the concurrent preparation of multiple single-serve beverages. The brewing units 411L, 411R are preferably contained within a single housing 412 that includes recesses 414L, 414R for each brewing unit 411L, 411R to receive and/or support at least a portion of a cup, pot, travel mug or other vessel (not shown) for receiving a beverage or liquid that exits the kitchen appliance 410. The brewing units 411L, 411R are preferably capable of independent operation and each includes its own components necessary to complete brewing operations. For example, each brewing unit 411L, 411R includes its own on/off button 486L, 486R and controller 424L, 424R.

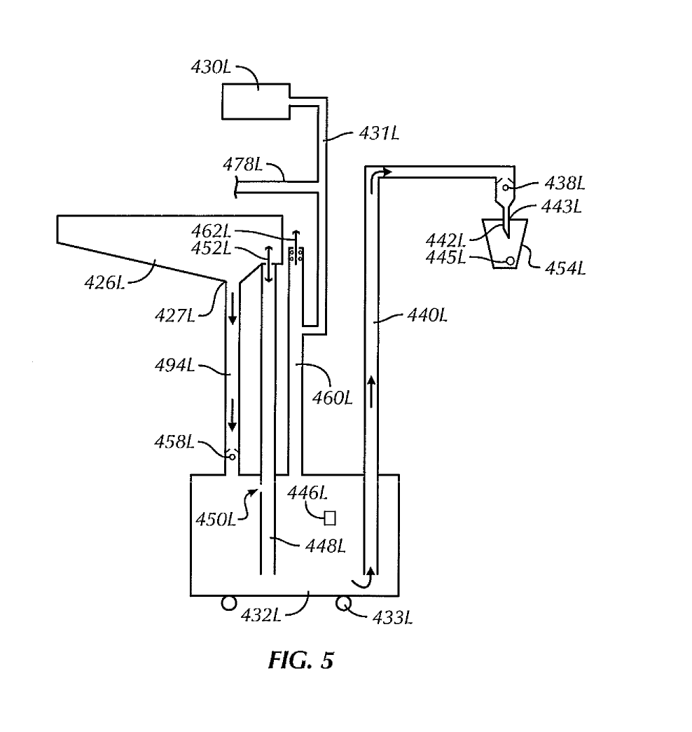

Hinged covers 476L, 476R are preferably provided at a top of the kitchen appliance 410 to allow access to baskets (not shown) in which the foodstuff may be placed proximate to the respective discharge ports 442L (FIG. 5). The hinged covers 476L, 476R also preferably provide access to the respective reservoirs 426L (FIG. 5). Thus, the user can enter the foodstuff and the water into the desired brewing unit 411L, 411R through the corresponding hinged cover 476L, 476R.

FIG. 5 is a schematic block diagram of various components of the one brewing unit 411L of the kitchen appliance 410 to illustrate the flow of fluid from the reservoir 426L through discharge. Unlike the first embodiment, the kitchen appliance 410 of the second embodiment preferably brews a beverage using the same amount of water that is poured into the reservoir 426L. However, systems similar to that of the first embodiment which allow selection of a cup size and automatic metering of the water may be used in one or more of the brewing units 411L, 411R of the kitchen appliance 410. Since the user pours the measured amount of water into the reservoir 426L, a water pump (such as that used in the first embodiment) is not necessary, and preferably water flows from the reservoir 426L to the boiler 432L via gravity. However, a water pump may be used if desired. The water proceeds from an outlet 427L of the reservoir 426L through a fill tube 494L and preferably a check valve 458L into the boiler 432L.

As before, a vent tube 448L is provided with a vent orifice 450L to allow air in the boiler 432L to escape as water from the reservoir 426L is received. The air preferably exits the vent tube 448L through a vent valve 452L located within the reservoir 426L, although the vented air may be directed to other locations as well. An overpressure tube 460L is also provided to vent excess pressure caused by a malfunction. The overpressure valve 462L is shown located outside of the reservoir 426L in FIG. 5, but may also be placed within the reservoir 426L, if desired.

A heater 433L of the brewing unit 411L heats the water in the boiler 432L, which is then discharged through a discharge tube 440L to a discharge port 442L by an air pump 430L. The discharge port 442L is protected by a check valve 438L. The air pump 430L preferably communicates with the interior of the boiler 432L by connecting to the overpressure tube 460, although other connection methods are possible. A pump line 431L connected to the air pump 430L may also branch into a pressure regulation tube (orifice) 478L that maintains an even pressure within the brew unit 411L during air pump 430L operation. A temperature sensor 446L is also present, either inside or outside of the boiler 432L, as before.

FIG. 5 shows the example where the foodstuff is contained within a container 454L having a top opening 443L made by the pointed end of the discharge port 442L. The discharge port 442L is preferably attached to the hinged cover 476L for movement therewith, such that the motion of closing the hinged cover 476L brings the pointed end of the discharge port 442L into contact with the container 454L to form the top opening 443L. A bottom opening 445L allows the infused beverage to leave the container 454L for dispensing into the cup or other vessel.

Operation of the heaters 433L, 433R in the two brew units 411L, 411R is preferably staggered because simultaneous operation thereof could result in power failure unless the heaters 433L, 433R use very little wattage, which is typically insufficient to brew a hot beverage in a reasonable amount of time. Accordingly, one or more controllers 424L, 424R is/are programmed to check for operation of the heater 433L, 433R in the opposing brew unit 411R, 411L prior to undertaking certain operational steps, as will be described in detail below.

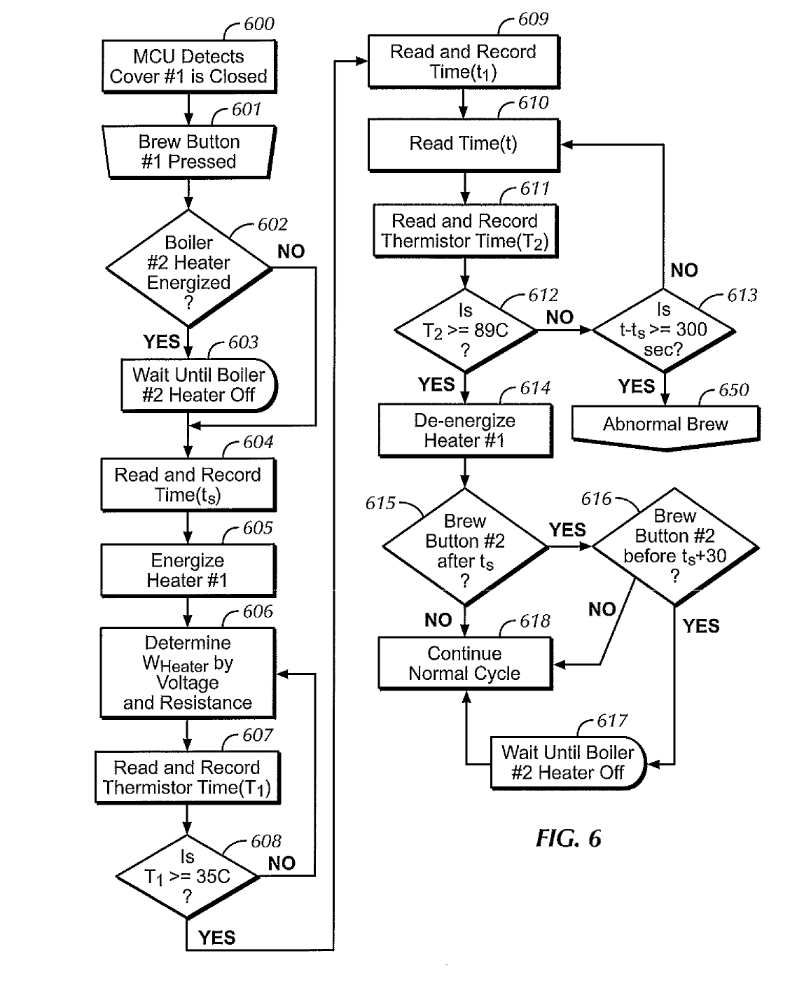

Referring to FIG. 6, a portion of a normal brew cycle for one of the brew units 411L of the appliance 410 is shown. The flow chart will be described with respect to operation of the first unit 411L, although operation of the second unit 411R is essentially identical, and therefore will not be repeated herein.

Once the user adds a capsule or loose grounds to the basket, at 600, the controller 424L preferably determines whether the hinged cover 476L is closed. A sensor (not shown) can be used to detect the closed state of the hinged cover 476L. The controller 424L at 601 detects a selection by the user of a button associated with brewing, e.g., the on/off button 486L. Prior to taking any further action, the controller 424L at 602 determines whether the heater 433R in the second brew unit 411R is currently energized. If so, the controller 424L at 603 detects the heater 433R in the second brew unit 411R to be turned off. Preferably the heater 433R in the second brew unit 411R is not forced off by the user's operation of the first brew unit 411L, but instead the heater 433R in the second brew unit 411R is permitted to complete its necessary actions as part of its normal operation in the second brew unit 411R.

Once the heater 433R in the second brew unit 411R is off, or if the controller 424L determines at 602 that the heater 433R in the second brew unit 411R is not energized, the controller 424L at 604 reads and records a heating start time tₛ and at 605 energizes the heater 433L. If desired, the controller 424L may also check to see if the last brew cycle completed by the first brew unit 411L was a normal brew cycle, and/or whether the first brew unit 411L should operate under a “hot start,” i.e., the heater 433L is already warm and will require less time to heat. At 606, an average wattage of the heater 433L is determined, based on voltage and resistance. Also, at 607, a first temperature T₁ is read and recorded from the temperature sensor 446L in the boiler 432L. The controller 424L at 608 then determines whether the first temperature T₁ is greater than or equal to a preset starting value. In the example of FIG. 6, the preset starting value is 35° C. If the first temperature T₁ is below the preset starting value, the controller 424L returns to 606 to determine the wattage of the heater 433L, as the value may change in order to heat the water in the boiler 432L within a reasonable amount of time.

If the first temperature T₁ is at or above the preset starting value, then the controller 424L at 609 reads and records an initial time t₁. Thereafter, the controller 424L at 610 periodically reads the current time t and at 611 reads and records a second temperature T₂. At 612, the controller 424L determines whether the second temperature T₂ is at or above a preset final value, such as 89° C. in the embodiment of FIG. 6. If not, the current time t is compared to the heating start time tₛ at 613, and if the difference is more than a predetermined amount of time (e.g., 300 seconds), the controller 424L determines at 650 that an abnormal brew has occurred. An error message may be provided to the user, preferably via a display (not shown). If the predetermined amount of time has not elapsed since the heating start time tₛ, the process returns to 610.

If at 612 the controller 424L determines that the second temperature T₂ is at or above the preset final value, the controller 424L de-energizes the heater 433L at 614. The controller 424L then checks at 615 whether the brew button (e.g., on/off button 486R) of the second brew unit 411R was pushed after the recorded heating start time L. If so, the controller 424L may determine at 616 whether the brew button in the second brew unit 411R was pressed after a predetermined amount of time, e.g., if thirty (30) seconds has elapsed since the heating start time tₛ. If the answer is “Yes,” the controller 424L will wait at 617 for the heater 433R in the second brew unit 411R to de-energize before continuing any further brewing action in the first brew unit 411L. If the brew button of the second brew unit 411R was not pressed, or was pressed shortly after the heating start time t_{S}, or once the heater 433R of the second brew unit 411R is de-energized, the controller 424L proceeds with a normal brew cycle for the first brew unit 411L at 618. For example, the controller 424L may continue on starting from step 339 in FIG. 3D (although it is noted that preferably steps 342-344 directed to checking the volume of water in the boiler 432L are omitted from the second embodiment).

From the foregoing, it can be seen that embodiments of the present disclosure comprise kitchen appliances, and particularly computer-controlled coffeemakers. It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

What is claimed is:

1. A kitchen appliance comprising:
(a) a hot liquid generator having an inlet and an outlet, and configured to receive a liquid therein;
(b) at least one heater in thermal communication with liquid in the hot liquid generator;
(c) at least one temperature sensor for sensing the temperature of liquid in the hot liquid generator;
(d) a discharge port in fluid communication with the outlet of the hot liquid generator;
(e) a first pump motivates liquid out of the hot liquid generator through the outlet to the discharge port; and
(f) a controller configured to:
(1) actuate the at least one heater to heat liquid in the hot liquid generator,
(2) receive signals from the at least one temperature sensor and record an elapsed time in which liquid in the hot liquid generator is heated from a first temperature to a second temperature,
(3) calculate the volume of the liquid in the hot liquid generator using the following formula:
(W×Δt)/(c×(T₂−T₁)×ρ)
wherein W is a wattage of the at least one heater, Δt is the elapsed time, c is a specific heat of liquid in the hot liquid generator, T₁ is the first temperature, T₂ is the second temperature, and ρ is a density of liquid in the hot liquid generator, and
(4) compare the calculated volume of liquid in the hot liquid generator to a range of expected volumes of liquid in the hot liquid generator,
whereby if the calculated volume is within a range of expected volumes, the controller is configured to actuate the first pump to pump liquid out of the hot liquid generator through the outlet to the discharge port, and if the calculated volume is outside of the range of expected volumes, the controller is configured to output an error signal.

2. The kitchen appliance of claim 1, wherein the controller is configured to receive, from the at least one temperature sensor, a first temperature measurement of liquid in the hot liquid generator prior to recording a start time.

3. The kitchen appliance of claim 2, wherein the controller is further configured to record the start time only if the received first temperature measurement is greater than or equal to a preset starting value, the first temperature being the last received first temperature measurement before the recorded start time.

4. The kitchen appliance of claim 3, wherein the controller is further configured to record an end time only if a received second temperature measurement is greater than or equal to a preset ending value, the second temperature being the last received second temperature measurement before the recorded end time, the elapsed time being a difference between the recorded start and end times.

5. The kitchen appliance of claim 1, further comprising a display configured to display an error message in response to receipt of the error signal from the controller.

6. The kitchen appliance of claim 5, wherein the error message indicates that liquid in the hot liquid generator must be purged.

7. The kitchen appliance of claim 1, further comprising an interface in communication with the controller and configured to receive input from the user, the controller being further configured to base the range of expected volumes of liquid in the hot liquid generator on at least a portion of the input from the user.

8. The kitchen appliance of claim 7, wherein the input from the user includes a selected cup size.

9. The kitchen appliance of claim 1, further comprising a reservoir in fluid communication with the inlet of the hot liquid generator and a second pump configured to pump liquid from the reservoir to the hot liquid generator.

10. A method of operating a kitchen appliance having a hot liquid generator, at least one heater in thermal communication with liquid in the hot liquid generator, a discharge port in fluid communication with the hot liquid generator, and a controller, the method comprising:
(a) using the at least one heater, heating liquid in the hot liquid generator from a first temperature to a second temperature;
(b) calculating an elapsed time in which liquid in the hot liquid generator was heated from the first temperature to the second temperature;
(c) calculating, using the controller, a volume of liquid in the hot liquid generator using the following formula:
(W×Δt)/(c×(T₂−T₁)×ρ)
wherein W is a wattage of the at least one heater, Δt is the elapsed time, c is a specific heat of liquid in the hot liquid generator, T₁ is the first temperature, T₂ is the second temperature, and ρ is a density of liquid in the hot liquid generator; and
(d) comparing, in the controller, the calculated volume of liquid in the hot liquid generator to a range of expected volumes of liquid in the hot liquid generator, whereby:
(1) if the calculated volume is within the range of expected volumes, liquid is pumped out of the hot liquid generator to the discharge port, and
(2) if the calculated volume is outside of the range of expected volumes, an error signal is output by the controller.

11. The method of claim 10, wherein the elapsed time is a difference between a recorded start time and a recorded end time, the method further comprising receiving a first temperature measurement of liquid in the hot liquid generator prior to recording the start time.

12. The method of claim 11, wherein the start time is recorded only if the received first temperature measurement is greater than or equal to a preset starting value, the first temperature being the last received first temperature measurement before the recorded start time.

13. The method of claim 12, further comprising recording the end time only if a received second temperature measurement is greater than or equal to a preset ending value, the second temperature being the last received second temperature measurement before the recorded end time.

14. The method of claim 10, wherein the kitchen appliance further includes a display, the method further comprising displaying, on the display, an error message in response to receipt from the controller of the error signal.

15. The method of claim 14, wherein the error message indicates that liquid in the hot liquid generator must be purged.

16. The method of claim 10, wherein the expected volume of liquid in the hot liquid generator is based on an input to the controller received from a user.

17. The method of claim 16, wherein the input from the user includes selection of a cup size.

18. The method of claim 10, wherein the kitchen appliance further includes a reservoir, the method further comprising pumping liquid from the reservoir into the hot liquid generator.
